(19) United States
(12) Patent Application Publication
(10) Pub. No.: US 2026/0096510 A1
(43) Pub. Date: Apr. 9, 2026

(54) HEADER ASSEMBLY FOR AN AGRICULTURAL HARVESTER

(71) Applicant: CNH Industrial America LLC, New Holland, PA (US)

(72) Inventors: Joseph Neil Oberlander, Durant, IA (US); Timothy Alan Meeks, Donahue, IA (US); Niels Dybro, Muscatine, IA (US)

(21) Appl. No.: 19/352,732

(22) Filed: Oct. 8, 2025

Related U.S. Application Data
(60) Provisional application No. 63/704,852, filed on Oct. 8, 2024.

(51) Int. Cl. A01D 41/14

(52) U.S. Cl. CPC A01D 41/145; A01D 41/141

(57) ABSTRACT

A header assembly for an agricultural harvester includes a lift arm pivotally coupled to a chassis of the agricultural harvester. The header assembly also includes a toolbar pivotally coupled to the lift arm, in which the toolbar supports a row unit. Furthermore, the header assembly includes a lift actuator pivotally coupled to the lift arm and pivotally coupled to the chassis of the agricultural harvester. The lift actuator drives the lift arm to rotate relative to the chassis to control a vertical position of the row unit relative to the chassis. In addition, the header assembly includes a tilt actuator pivotally coupled to the lift arm and to the toolbar. The tilt actuator drives the toolbar to rotate relative to the lift arm to control an orientation of the row unit relative to the chassis.

### CROSS-REFERENCE TO RELATED APPLICATION

This application claims priority from and the benefit of U.S. Provisional Application Serial No. 63/704,852, entitled “HEADER ASSEMBLY FOR AN AGRICULTURAL HARVESTER”, filed October 8, 2024, which is hereby incorporated by reference in its entirety.

### BACKGROUND

The present disclosure relates generally to a header assembly for an agricultural harvester.

Agricultural harvesters are used to harvest agricultural products (e.g., cotton or other natural material(s)). For example, an agricultural harvester may include a header assembly having row units configured to harvest the agricultural product from a field. The agricultural harvester may also include an air-assisted conveying system configured to move the agricultural product from the row units to an accumulator. The agricultural product may then be fed into a baler via a conveying system. The baler may compress the agricultural product into a package to facilitate storage, transport, and handling of the agricultural product. For example, a round baler may compress the agricultural product into a round bale within a baling chamber, such that the round bale has a desired size and density. After forming the bale, the bale may be wrapped with a bale wrap to secure the agricultural product within the bale and to generally maintain the shape of the bale.

In certain agricultural harvesters, the header assembly includes a toolbar and a four-bar linkage that couples the toolbar to a chassis of the agricultural harvester. The toolbar is configured to support the row units, and the four-bar linkage is configured to enable vertical movement of the toolbar relative to the chassis. In addition, the header assembly may include an actuator coupled to the chassis and to the four-bar linkage, in which the actuator is configured to drive the toolbar to move upwardly and downwardly, thereby controlling a vertical position of the row units relative to the chassis. Unfortunately, due to the size of the four-bar linkage, the operator’s view of crop inlets of the row units may be partially obscured.

### BRIEF DESCRIPTION

In certain embodiments, a header assembly for an agricultural harvester includes a lift arm configured to pivotally couple to a chassis of the agricultural harvester. The header assembly also includes a toolbar pivotally coupled to the lift arm, in which the toolbar is configured to support a row unit. Furthermore, the header assembly includes a lift actuator pivotally coupled to the lift arm and configured to pivotally couple to the chassis of the agricultural harvester. The lift actuator is configured to drive the lift arm to rotate relative to the chassis of the agricultural harvester to control a vertical position of the row unit relative to the chassis of the agricultural harvester. In addition, the header assembly includes a tilt actuator pivotally coupled to the lift arm and to the toolbar. The tilt actuator is configured to drive the toolbar to rotate relative to the lift arm to control an orientation of the row unit relative to the chassis of the agricultural harvester.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural harvester having a header assembly;

FIG. 2 is a perspective view of an embodiment of a header assembly that may be employed within the agricultural harvester of FIG. 1; and

FIG. 3 is a side view of the header assembly of FIG. 2.

### DETAILED DESCRIPTION

In certain agricultural harvesters, a header assembly includes a toolbar and a four-bar linkage that couples the toolbar to a chassis of the agricultural harvester. The toolbar is configured to support row units, and the four-bar linkage is configured to enable vertical movement of the toolbar relative to the chassis. In addition, the header assembly may include an actuator coupled to the chassis and to the four-bar linkage, in which the actuator is configured to drive the toolbar to move upwardly and downwardly, thereby controlling a vertical position of the row units relative to the chassis. Unfortunately, due to the size of the four-bar linkage, the operator’s view of crop inlets of the row units may be partially obscured.

The present disclosure provides a technological improvement to the status quo by enabling an automated adjustment of the row unit harvesting angles that maintains an operator set harvesting angle throughout a predetermined harvesting height range without utilizing a four-bar linkage architecture or operator involvement or input.

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

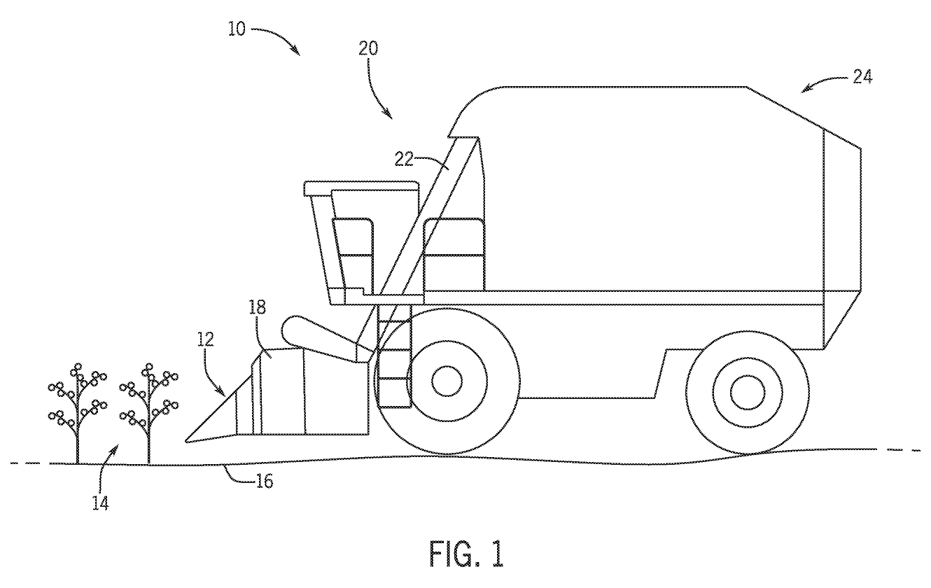

FIG. 1 is a side view of an embodiment of an agricultural harvester 10 having a header assembly 12. The agricultural harvester 10 is configured to harvest agricultural product 14 (e.g., seed cotton) from a field 16 and to form the agricultural product 14 into bales (e.g., agricultural bales). In the illustrated embodiment, the header assembly 12 of the agricultural harvester 10 includes multiple row units 18 distributed across the width of the header assembly 12. Each row unit 18 is configured to harvest a respective row of the agricultural product 14 from the field 16. Additionally, the agricultural harvester 10 includes an agricultural product transport assembly 20 having an air-assisted conveying system 22 configured to move the agricultural product 14 from the row units 18 of the header assembly 12 to an accumulator of the agricultural product transport assembly 20. The agricultural product transport assembly 20 also includes a conveying system configured to convey the agricultural product 14 from the accumulator into a baler 24. The baler 24 is supported by and/or mounted within or on a chassis of the agricultural harvester 10. The baler 24 may form the agricultural product 14 into round bales. However, in other embodiments, the baler 24 of the agricultural harvester 10 may form the agricultural product into square bales, polygonal bales, or bales of other suitable shape(s). After forming the agricultural product 14 into a bale, a bale wrapping system of the agricultural harvester 10 wraps the bale with a bale wrap to secure the agricultural product 14 within the bale and to generally maintain a shape of the bale.

In certain embodiments, the header assembly 12 includes a lift arm pivotally coupled to the chassis of the agricultural harvester. In addition, the header assembly 12 includes a toolbar pivotally coupled to the lift arm, in which the toolbar is configured to support multiple row units 18. Furthermore, the header assembly 12 includes a lift actuator pivotally coupled to the lift arm and to the chassis of the agricultural harvester. The lift actuator is configured to drive the lift arm to rotate relative to the chassis of the agricultural harvester to control a vertical position of the row units 18 relative to the chassis of the agricultural harvester. The header assembly 12 also includes a tilt actuator pivotally coupled to the lift arm and to the toolbar. The tilt actuator is configured to drive the toolbar to rotate relative to the lift arm to control an orientation of the row units relative to the chassis of the agricultural harvester. Because the toolbar is movably coupled to the chassis of the agricultural harvester via the lift arm, the visibility of crop inlets of the row units 18 may be enhanced (e.g., as compared to a toolbar movably coupled to the chassis via a four-bar linkage).

Furthermore, in certain embodiments, the header assembly includes a controller communicatively coupled to the lift actuator and to the tilt actuator, in which the controller includes a processor and a memory. The controller is configured to control the lift actuator to control the vertical position of the row units 18 relative to the chassis of the agricultural harvester 10, and the controller is configured to control the tilt actuator to control the orientation of the row units 18 relative to the chassis of the agricultural harvester 10. Furthermore, in certain embodiments, the controller is configured to control the tilt actuator based on actuation of the lift actuator to maintain the orientation of the row units 18 relative to the chassis of the agricultural harvester 10 as the lift actuator varies the vertical position of the row units 18 relative to the chassis of the agricultural harvester 10. For example, in response to instructions to raise the row units 18 relative to the chassis of the agricultural harvester, the controller may control the lift actuator to increase the vertical position of the row units 18 relative to the chassis of the agricultural harvester 10, and the controller may control the tilt actuator based on actuation of the lift actuator to maintain the orientation of the row units 18 relative to the chassis of the agricultural harvester 10 as the lift actuator increases the vertical position of the row units 18 relative to the chassis of the agricultural harvester 10. As a result, the lift arm may perform the same function as a four-bar linkage (e.g., maintaining the orientation of the row units during a change in vertical position) while enhancing the visibility of the crop inlets of the row units 18 (e.g., as compared to a header assembly having a four-bar linkage).

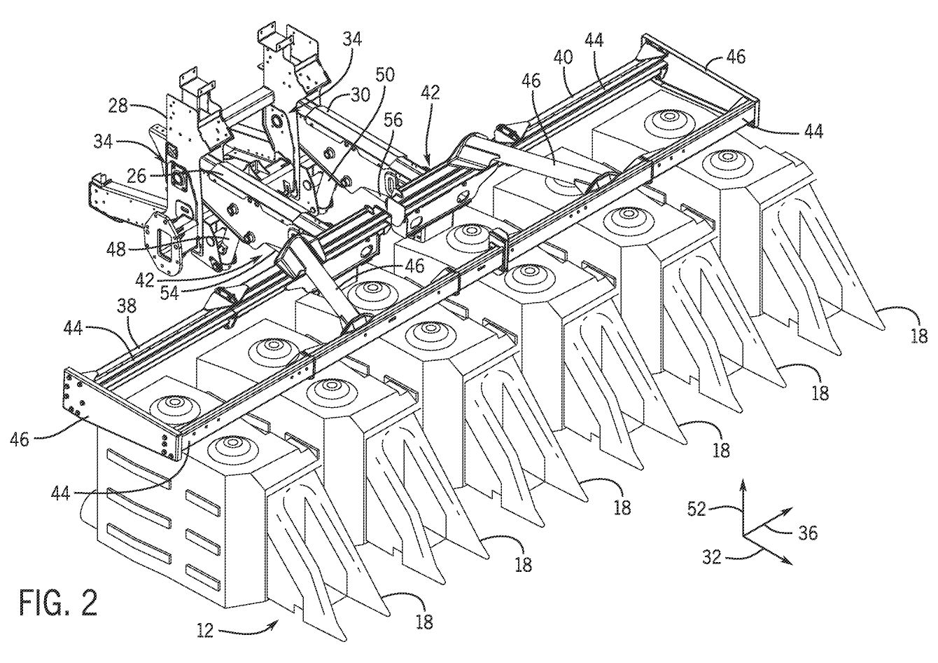

FIG. 2 is a perspective view of an embodiment of a header assembly 12 that may be employed within the agricultural harvester of FIG. 1. In the illustrated embodiment, the header assembly 12 includes a first lift arm 26 (e.g., lift arm) pivotally coupled to the chassis 28 of the agricultural harvester and a second lift arm 30 pivotally coupled to the chassis 28 of the agricultural harvester. As illustrated, each lift arm extends forwardly with respect to a longitudinal axis 32 of the agricultural harvester. In addition, each lift arm is pivotally coupled to the chassis 28 by a respective pivot joint 34, thereby enabling the lift arms to pivot about a pivot axis (e.g., parallel to a lateral axis 36 of the agricultural harvester). Each pivot joint may include any suitable element(s) configured to pivotally couple the respective lift arm to the chassis 28, such as shaft(s), pin(s), bushing(s), bearing(s), other suitable element(s), or a combination thereof.

Furthermore, in the illustrated embodiment, the header assembly 12 includes a first toolbar 38 (e.g., toolbar) pivotally coupled to the first lift arm 26, and the header assembly 12 includes a second toolbar 40 pivotally coupled to the second lift arm 30. As illustrated, each toolbar extends laterally (e.g., with respect to the lateral axis 36), and each toolbar is configured to support multiple row units 18. In the illustrated embodiment, the first toolbar 38 is configured to support three row units 18, and the second toolbar 40 is configured to support three row units 18. However, in other embodiments, each toolbar may be configured to support more or fewer row units (e.g., 1, 2, 4, 5, 6, or more). In addition, each toolbar is pivotally coupled to the respective lift arm by a respective pivot joint 42, thereby enabling each toolbar to pivot about a respective pivot axis (e.g., parallel to the lateral axis 36). Each pivot joint may include any suitable element(s) configured to pivotally couple the respective toolbar to the respective lift arm, such as shaft(s), pin(s), bushing(s), bearing(s), other suitable element(s), or a combination thereof.

Furthermore, in the illustrated embodiment, each toolbar includes two lateral bars 44 and two cross-bars 46. Each cross-bar 46 may be coupled to each respective lateral bar 44 by any suitable type(s) of connection(s), such as a welded connection, a fastener connection, an adhesive connection, other suitable type(s) of connection(s), or a combination thereof. In the illustrated embodiment, each row unit 18 is slidably coupled to a respective forward lateral bar 44 of the respective toolbar, thereby enabling a position of the row unit 18 to be adjusted with respect to the lateral axis 36 to accommodate different row spacings. However, in other embodiments, at least one row unit may be slidably coupled to a respective rearward lateral bar or to another suitable component of the respective toolbar. Furthermore, in certain embodiments, at least one row unit (e.g., each row unit) may be non-movably coupled to the respective toolbar. In addition, while each toolbar includes two lateral bars 44 and two cross-bars 46 in the illustrated embodiment, in other embodiments, at least one toolbar (e.g., each toolbar) may include any other suitable structural configuration (e.g., including 1, 3, 4, or more lateral bars, including 1, 3, 4, or more cross-bars, including other suitable structural component(s), etc.).

In the illustrated embodiment, the header assembly 12 also includes a first lift actuator 48 and a second lift actuator 50. The first lift actuator 48 is pivotally coupled to the first lift arm 26 and to the chassis 28. The first lift actuator 48 is configured to drive the first lift arm 26 to rotate relative to the chassis 28 to control a vertical position of the row units 18 coupled to the first toolbar 38 relative to the chassis 28 (e.g., a position of the row units 18 with respect to a vertical axis 52 of the agricultural harvester relative to the chassis 28). Furthermore, the second lift actuator 50 is pivotally coupled to the second lift arm 30 and to the chassis 28. The second lift actuator 50 is configured to drive the second lift arm 30 to rotate relative to the chassis 28 to control a vertical position of the row units 18 coupled to the second toolbar 40 relative to the chassis 28 (e.g., a position of the row units 18 with respect to the vertical axis 52 relative to the chassis 18). Each lift actuator may include any suitable type(s) of actuation device(s), such as one or more hydraulic cylinders, one or more pneumatic cylinders, one or more electric linear actuators, other suitable type(s) of actuation device(s), or a combination thereof.

Furthermore, in the illustrated embodiment, the header assembly 12 includes a first tilt actuator 54 and a second tilt actuator 56. The first tilt actuator 54 is pivotally coupled to the first lift arm 26 and to the first toolbar 38. The first tilt actuator 54 is configured to drive the first toolbar 38 to rotate relative to the first lift arm 26 to control an orientation of the row units 18 coupled to the first toolbar 38 relative to the chassis 28. Furthermore, the second tilt actuator 56 is pivotally coupled to the second lift arm 30 and to the second toolbar 40. The second tilt actuator 56 is configured to drive the second toolbar 40 to rotate relative to the second lift arm 30 to control an orientation of the row units 18 coupled to the second toolbar 40 relative to the chassis 28. Each tilt actuator may include any suitable type(s) of actuation device(s), such as one or more hydraulic cylinders, one or more pneumatic cylinders, one or more electric linear actuators, other suitable type(s) of actuation device(s), or a combination thereof.

In certain embodiments, the header assembly 12 includes a controller communicatively coupled to the lift actuators and to the tilt actuators. The controller includes a processor and a memory, and the controller is configured to control the lift actuators to control the vertical position(s) of the row units 18 (e.g., the position of the row units 18 with respect to the vertical axis 52) relative to the chassis 28 of the agricultural harvester, and the controller is configured to control the tilt actuators to control the orientation(s) of the row units 18 relative to the chassis 28 of the agricultural harvester. In certain embodiments, the controller is configured to control the tilt actuators based on actuation of the lift actuators to maintain the orientation(s) of the row units 18 relative to the chassis 28 of the agricultural harvester as the lift actuators vary the vertical position(s) of the row units 18 relative to the chassis 28 of the agricultural harvester. For example, in response to instructions to raise the row units 18 relative to the chassis 28 of the agricultural harvester, the controller may control the lift actuators to increase the vertical position of the row units 18 relative to the chassis of the agricultural harvester, and the controller may control the tilt actuators based on actuation of the lift actuators to maintain the orientation of the row units 18 relative to the chassis 28 of the agricultural harvester as the lift actuators increase the vertical position of the row units 18 relative to the chassis 28 of the agricultural harvester. As a result, the lift arms may perform the same function as a four-bar linkage (e.g., maintaining the orientation of the row units during a change in vertical position) while enhancing the visibility of the crop inlets of the row units 18 (e.g., as compared to a header assembly having a four-bar linkage).

In the illustrated embodiment, the header assembly 12 includes two lift arms, two toolbars, two lift actuators, and two tilt actuators. However, in other embodiments, the header assembly may include more or fewer lift arms, toolbars, lift actuators, and tilt actuators. For example, in certain embodiments, the header assembly may include a single lift arm, a single toolbar, a single lift actuator, and a single tilt actuator. Furthermore, in certain embodiments, the header assembly may include more than two lift arms (e.g., 3, 4, or more), more than two toolbars (e.g., 3, 4, or more), more than two lift actuators (e.g., 3, 4, or more), and more than two tilt actuators (e.g., 3, 4, or more). Furthermore, while a single lift arm is coupled to each toolbar in the illustrated embodiment, in other embodiments, multiple lift arms (e.g., 2, 3, 4, or more) may be coupled to at least one toolbar. In such embodiments, one lift actuator may be coupled to each lift arm, or a lift actuator may not be coupled to at least one lift arm. In addition, while a single toolbar is coupled to each lift arm in the illustrated embodiment, in other embodiments, multiple toolbars may be coupled to at least one lift arm. In such embodiments, one tilt actuator may be coupled to each toolbar.

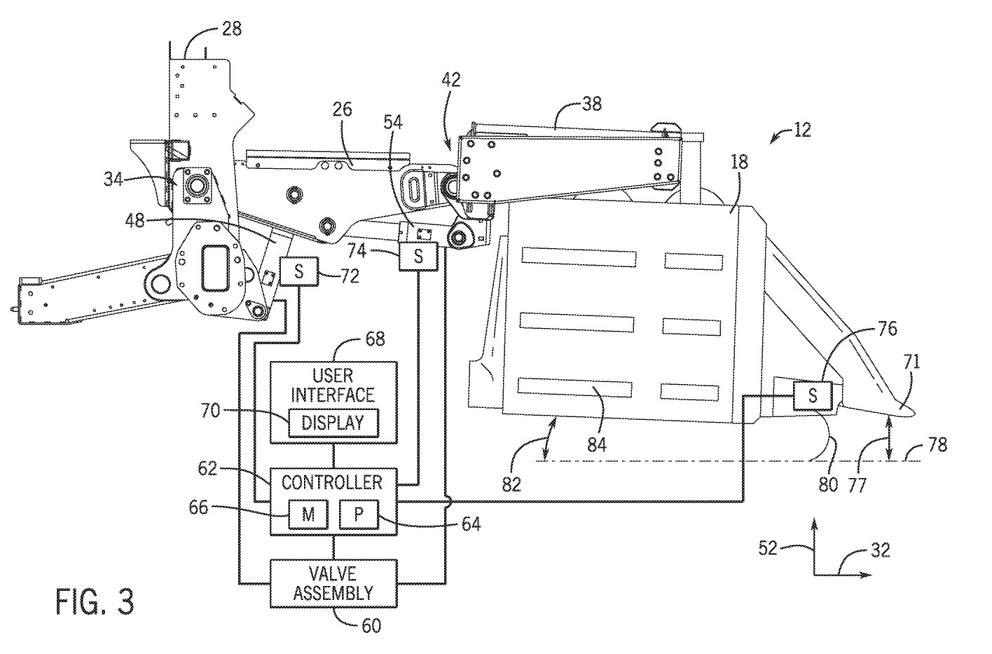

FIG. 3 is a side view of the header assembly of FIG. 2. As previously discussed, the first lift arm 26 is pivotally coupled to the chassis 28 by the respective pivot joint 34, thereby enabling the first lift arm 26 to pivot about a pivot axis (e.g., parallel to the lateral axis). In addition, the first toolbar 38 is pivotally coupled to the first lift arm 26 by the respective pivot joint 42, thereby enabling the first toolbar 38 to pivot about a respective pivot axis (e.g., parallel to the lateral axis). Furthermore, the first lift actuator 48 is pivotally coupled to the first lift arm 26 and to the chassis 28. The first lift actuator 48 is configured to drive the first lift arm 26 to rotate relative to the chassis 28 to control the vertical position of the row units 18 coupled to the first toolbar 38 relative to the chassis 28 (e.g., the position of the row units 18 with respect to the vertical axis 52 relative to the chassis 28). In addition, the first tilt actuator 54 is pivotally coupled to the first lift arm 26 and to the first toolbar 38. The first tilt actuator 54 is configured to drive the first toolbar 38 to rotate relative to the first lift arm 26 to control the orientation of the row units 18 coupled to the first toolbar 38 relative to the chassis 28.

In the illustrated embodiment, the first lift actuator 48 includes a single hydraulic cylinder. The hydraulic cylinder of the first lift actuator 48 is arranged such that extension of a piston rod of the hydraulic cylinder drives the first lift arm 26 to pivot upwardly and retraction of the piston rod of the hydraulic cylinder drives the first lift arm 26 to pivot downwardly. In addition, the first tilt actuator 54 includes a single hydraulic cylinder. The hydraulic cylinder of the first tilt actuator 54 is arranged such that extension of a piston rod of the hydraulic cylinder drives the first toolbar 38 to pivot upwardly and retraction of the piston rod of the hydraulic cylinder drives the first toolbar 38 to pivot downwardly.

In the illustrated embodiment, the header assembly 12 includes a valve assembly 60 fluidly coupled to each hydraulic cylinder of each lift actuator (e.g., including the single hydraulic cylinder of the first lift actuator 48) and to each hydraulic cylinder of each tilt actuator (e.g., including the single hydraulic cylinder of the first tilt actuator 54). The valve assembly 60 may include any suitable type(s) of valves to control fluid flow from a fluid source (e.g., pump, etc.) to each hydraulic cylinder and to control fluid flow from each hydraulic cylinder to a reservoir. For example, in certain embodiments, the valve assembly 60 may include at least one lift valve configured to control fluid flow from the fluid source to the hydraulic cylinder(s) of each lift actuator and to control fluid flow from the hydraulic cylinder(s) of each lift actuator to the reservoir. In addition, in certain embodiments, the valve assembly 60 may include at least one tilt valve configured to control fluid flow from the fluid source to the hydraulic cylinder(s) of each tilt actuator and to control fluid flow from the hydraulic cylinder(s) of each tilt actuator to the reservoir.

In the illustrated embodiment, the header assembly 12 includes a controller 62 communicatively coupled to the valve assembly 60. In certain embodiments, the controller 62 is an electronic controller having electrical circuitry configured to control the valve assembly 60. In the illustrated embodiment, the controller 62 includes a processor 64, such as a microprocessor, and a memory device 66. The controller 62 may also include one or more storage devices and/or other suitable components. The processor 64 may be used to execute software, such as software for controlling the valve assembly 60, and so forth. Moreover, the processor 64 may include multiple microprocessors, one or more “general-purpose” microprocessors, one or more special-purpose microprocessors, and/or one or more application specific integrated circuits (ASICs), or some combination thereof. For example, the processor 64 may include one or more reduced instruction set (RISC) processors.

The memory device 66 may include a volatile memory, such as random access memory (RAM), and/or a nonvolatile memory, such as read-only memory (ROM). The memory device 66 may store a variety of information and may be used for various purposes. For example, the memory device 66 may store processor-executable instructions (e.g., firmware or software) for the processor 64 to execute, such as instructions for controlling the valve assembly 60, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the valve assembly 60, etc.), and any other suitable data.

In the illustrated embodiment, the header assembly 12 includes a user interface 68 communicatively coupled to the controller 62. The user interface 68 is configured to receive input from an operator and to provide information to the operator. The user interface 68 may include any suitable input device(s) for receiving input, such as a keyboard, a mouse, button(s), switch(es), knob(s), other suitable input device(s), or a combination thereof. In addition, the user interface 68 may include any suitable output device(s) for presenting information to the operator, such as speaker(s), indicator light(s), other suitable output device(s), or a combination thereof. In the illustrated embodiment, the user interface 68 includes a display 70 configured to present visual information to the operator. In certain embodiments, the display 70 may include a touchscreen interface configured to receive input from the operator.

The controller 62 is configured to control the first lift actuator 48 to control the vertical position of the row units 18 coupled to the first toolbar 38 relative to the chassis 28, and the controller 62 is configured to control the first tilt actuator 54 to control the orientation of the row units 18 coupled to the first toolbar 38 relative to the chassis 28. In the illustrated embodiment, the controller 62 is communicatively coupled to the valve assembly 60, and the valve assembly 60 is fluidly coupled to the first lift actuator 48 and to the first tilt actuator 54. Accordingly, the controller 62 is communicatively coupled to the first lift actuator 48 and to the first tilt actuator 54 via the valve assembly 60. As such, the controller 62 is configured to control the valve assembly 60 to control the hydraulic cylinder of the first lift actuator 48 to control the vertical position of the row units 18 coupled to the first toolbar 38 relative to the chassis 28, and the controller 62 is configured to control the hydraulic cylinder of the first tilt actuator 54 to control the orientation of the row units 18 coupled to the first toolbar 38 relative to the chassis 28. As used herein, “vertical position” of each row unit 18 relative to the chassis 28 refers to a position of a forward longitudinal end 71 of the row unit 18 with respect to the vertical axis 52 relative to the chassis 28. Furthermore, as used herein, “orientation” of each row unit 18 relative to the chassis 28 refers to a pitch of the row unit 18 (e.g., about the lateral axis of the agricultural harvester) relative to the chassis 28.

In the illustrated embodiment, the header assembly 12 includes a lift sensor 72 communicatively coupled to the controller 62 and configured to monitor actuation of the first lift actuator 48. For example, the lift sensor 72 may monitor extension and retraction of the piston rod of the hydraulic cylinder of the lift actuator 48. Furthermore, in the illustrated embodiment, the header assembly 12 includes a tilt sensor 74 communicatively coupled to the controller 62 and configured to monitor actuation of the first tilt actuator 54. Each sensor may include any suitable sensing device(s), such as one or more linear variable differential transformers, one or more linear potentiometers, one or more inductive sensors, one or more Hall effect sensors, one or more capacitive sensors, one or more ultrasonic sensors, one or more optical sensors, one or more other suitable type(s) of sensing device(s), or a combination thereof. In certain embodiments, each sensor may be configured to directly monitor actuation of the respective actuator. However, in other embodiments, at least one sensor may be configured to monitor actuation of the respective actuator(s) indirectly. For example, the lift sensor may be configured to monitor rotation of the first lift arm relative to the chassis, and/or the tilt sensor may be configured to monitor rotation of the first toolbar relative to the first lift arm.

In certain embodiments, the controller 62 is configured to control the first tilt actuator 54 (e.g., via the valve assembly 60) based on actuation of the first lift actuator 48 (e.g., as determined based on feedback from the lift sensor 72). For example, the controller 62 may control the first tilt actuator 54 based on actuation of the first lift actuator 48 to maintain the orientation of the row units 18 coupled to the first toolbar 38 relative to the chassis 28 as the lift actuator 48 varies the vertical position of the row units 18 coupled to the first toolbar 38 relative to the chassis 28. By way of example, the operator may provide an input to the user interface 68 indicative of instructions to increase the vertical position of the row units 18 relative to the chassis 28, and the user interface 68 may output the instructions to the controller 62. The controller 62, in turn, may control the first lift actuator 48 to drive the first lift arm 26 to rotate upwardly, thereby increasing the vertical position of the row units 18 coupled to the first toolbar 38 relative to the chassis 28. In addition, based on feedback from the lift sensor 72, the controller 62 may control the first tilt actuator 54 to drive the first toolbar 38 to rotate downwardly as the first lift actuator 48 drives the first lift arm 26 to rotate upwardly, thereby maintaining the orientation of the row units 18 coupled to the first toolbar 38 relative to the chassis 28. As a result, the first lift arm 26 may perform the same function as a four-bar linkage (e.g., maintaining the orientation of the row units 18 during a change in vertical position) while enhancing the visibility of the crop inlets of the row units 18 (e.g., as compared to a header assembly having a four-bar linkage). As used herein, “maintain the orientation” refers to maintaining the orientation within a threshold angular range. For example, the threshold angular range may be 6 degrees (e.g., positive 3 degrees to negative 3 degrees), 4 degrees (e.g., positive 2 degrees to negative 2 degrees), 2 degrees (e.g., positive 1 degree to negative 1 degree), or 1 degree (e.g., positive 0.5 degrees to negative 0.5 degrees).

Furthermore, in certain embodiments, the controller 62 is configured to control the first lift actuator 48 (e.g., via the valve assembly 60) based on actuation of the first tilt actuator 54 (e.g., as determined based on feedback from the tilt sensor 74). For example, the controller 62 may control the first lift actuator 48 based on actuation of the first tilt actuator 54 to maintain the vertical position of the row units 18 coupled to the first toolbar 38 relative to the chassis 28 as the tilt actuator 54 varies the orientation of the row units 18 coupled to the first toolbar 38 relative to the chassis 28. By way of example, the operator may provide an input to the user interface 68 indicative of instructions to rotate the row units 18 (e.g., about the lateral axis) to increase the angle of the row units 18 relative to the chassis 28 (e.g., to decrease a difference in the vertical positions between the forward longitudinal end 71 of each row unit 18 and a rearward longitudinal end of the row unit), and the user interface 68 may output the instructions to the controller 62. The controller 62, in turn, may control the first tilt actuator 54 to drive the first toolbar 38 to rotate upwardly, thereby increasing the angle of the row units 18 coupled to the first toolbar 38. In addition, based on feedback from the tilt sensor 74, the controller 62 may control the first lift actuator 48 to drive the first lift arm 26 to rotate downwardly as the first tilt actuator 54 drives the first toolbar 38 to rotate upwardly, thereby maintaining the vertical position of the row units 18 coupled to the first toolbar 38 relative to the chassis 28. As a result, the orientation of the row units 18 may be adjusted by the actuators during operation of the agricultural harvester, thereby enhancing the efficiency of the harvesting operation (e.g., as compared to a header assembly having a mechanical row unit orientation adjustment assembly that may only be adjusted while the agricultural harvester is not engaged in harvesting operations). As used herein, “maintain the vertical position” refers to maintaining the vertical position within a threshold vertical extent. For example, the threshold vertical extent may be 6 cm (e.g., positive 3 cm to negative 3 cm), 4 cm (e.g., positive 2 cm to negative 2 cm), 2 cm (e.g., positive 1 cm to negative 1 cm), or 1 cm (e.g., positive 0.5 cm to negative 0.5 cm).

Due to the arrangement of the actuators, the piston rod of the hydraulic cylinder of one actuator (e.g., the lift actuator or the tilt actuator) moves in the opposite direction of the piston rod of the hydraulic cylinder of the other actuator (e.g., the tilt actuator or the lift actuator) while adjusting the vertical position of the row units and while adjusting the orientation of the row units. For example, to increase the vertical position of the row units coupled to the first toolbar, the piston rod of the hydraulic cylinder of the first lift actuator is extended. Concurrently, the piston rod of the hydraulic cylinder of the first tilt actuator is retracted to maintain the orientation of the row units coupled to the first toolbar relative to the chassis. In addition, to increase the angle of the row units coupled to the first toolbar, the piston rod of the hydraulic cylinder of the first tilt actuator is extended. Concurrently, the piston rod of the hydraulic cylinder of the first lift actuator is retracted to maintain the vertical position of the row units coupled to the first toolbar relative to the chassis.

In certain embodiments, the controller 62 may utilized stored data to control the tilt actuator based on actuation of the respective lift actuator and to control the lift actuator based on actuation of the respective tilt actuator. For example, the controller 62 may store data indicative of a relationship between actuation of the lift actuator and actuation of the tilt actuator (e.g., in the form of a look-up table, an empirical formula, etc.), and the controller may utilize the relationship to control one actuator (e.g., the lift actuator or the tilt actuator) based on actuation of the other actuator (e.g., the tilt actuator or the lift actuator). Furthermore, in certain embodiments, the controller 62 may store the geometry of the header assembly 12, and the controller 62 may utilize the geometry to control the tilt actuator based on actuation of the respective lift actuator and to control the lift actuator based on actuation of the respective tilt actuator.

In the illustrated embodiment, the header assembly 12 includes a row unit height sensor 76 communicatively coupled to the controller 62. The row unit height sensor 76 is configured to output a sensor signal indicative of a height 77 of a respective row unit 18 above a ground surface 78 (e.g., with respect to the vertical axis 52). In the illustrated embodiment, the row unit height sensor 76 includes a ground contact element 80 configured to contact the ground surface 78. The row unit height sensor 76 is configured to monitor deflection of the ground contact element 80, thereby enabling the row unit height sensor 76 to output the sensor signal indicative of the height 77 of the respective row unit 18 above the ground surface 78 (e.g., with respect to the vertical axis 52). While the row unit height sensor 76 includes the ground contact element 80 in the illustrated embodiment, in other embodiments, the row unit height sensor may include one or more non-contact sensing devices, such as ultrasonic sensor(s), radar sensor(s), LiDAR sensor(s), other suitable sensing device(s), or a combination thereof. Furthermore, in certain embodiments, the header assembly 12 may include a single row unit height sensor 76 configured to monitor the height 77 of one row unit 18 above the ground surface 78, or the header assembly may include multiple row unit height sensors configured to monitor the heights of multiple row units above the ground surface. As used herein, “height” of each row unit 18 above the ground surface 78 refers to a height 77 of the forward longitudinal end 71 of the row unit 18 above the ground surface 78 (e.g., with respect to the vertical axis 52).

The controller 62 is configured to receive the sensor signal from each row unit height sensor 76 associated with the row units coupled to the first toolbar 38 and to control the first lift actuator 48 and/or the first tilt actuator 54 based on the height(s) of the row units 18 coupled to the first toolbar 38 above the ground surface 78. For example, in embodiments in which the header assembly includes a single row unit height sensor 76 associated with the row units coupled to the first toolbar 38, the controller 62 may control the first lift actuator 48 and/or the first tilt actuator 54 based on the height of the one row unit 18 associated with the one row unit height sensor 76 above the ground surface 78. Furthermore, in embodiments in which the header assembly includes multiple row unit height sensors 76 associated with the row units coupled to the first toolbar 38, the controller 62 may determine an average height based on feedback from the row unit height sensors 76, and the controller may control the first lift actuator 48 and/or the first tilt actuator 54 based on the average height. In addition, in embodiments in which the header assembly includes multiple row unit height sensors 76 associated with the row units coupled to the first toolbar 38, the controller 62 may determine a maximum height or a minimum height based on feedback from the row unit height sensors 76, and the controller may control the first lift actuator 48 and/or the first tilt actuator 54 based on the maximum height or the minimum height. Furthermore, in certain embodiments, the controller 62 is configured to instruct the user interface 68 to present the height(s) of the row units 18 coupled to the first toolbar 38 above the ground surface 78 and, in certain embodiments, the average height, the minimum height, the maximum height, or a combination thereof, via the display 70.

In certain embodiments, the operator may input a target row unit height into the user interface 68, and the user interface 68 may output the target row unit height to the controller 62. The controller 62, in turn, may control the first lift actuator 48 and the first tilt actuator 54 based on the target row unit height and feedback from the row unit height sensor(s). For example, in certain embodiments, in response to determining the difference between the target row unit height and the monitored row unit height (e.g., the row unit height determined based on feedback from one row unit height sensor, the average row unit height, the minimum row unit height, the maximum row unit height, etc.) exceeds a threshold value, the controller 62 may control the first lift actuator 48 to adjust the vertical position of the row units 18 coupled to the first toolbar 38 to reduce the difference between the target row unit height and the monitored row unit height, such that the difference is less than or equal to the threshold value. In addition, the controller 62 may control the first tilt actuator 54 based on actuation of the first lift actuator 48 to maintain the orientation of the row units 18 coupled to the first toolbar 38 relative to the chassis 28 as the first lift actuator 48 varies the vertical position of the row units 18 coupled to the first toolbar 38 relative to the chassis 28.

Furthermore, in certain embodiments, in response to determining the difference between the target row unit height and the monitored row unit height (e.g., the row unit height determined based on feedback from one row unit height sensor, the average row unit height, the minimum row unit height, the maximum row unit height, etc.) exceeds the threshold value, the controller 62 may determine whether the pitch (e.g., fore-aft tilt) of the agricultural harvester is greater than a threshold pitch (e.g., based on feedback from an agricultural harvester tilt sensor). In response to determining that the pitch of the agricultural harvester is less than or equal to the threshold pitch (e.g., which may indicate the agricultural harvester is on a substantially level ground surface), the controller 62 may control the first tilt actuator 54 to adjust the orientation of the row units 18 coupled to the first toolbar 38 relative to the chassis 28 to reduce the difference between the target row unit height and the monitored row unit height, such that the difference is less than or equal to the threshold value. Because the pitch of the agricultural harvester is less than or equal to the threshold pitch, the difference between the target row unit height and the monitored row unit height may be caused by a local ground feature (e.g., divot, groove, etc.). Accordingly, adjusting the orientation of the row units 18 coupled to the first toolbar 38 may enable the row units 18 to follow the contour of the local ground feature. However, in response to determining that the pitch of the agricultural harvester is greater than the threshold pitch (e.g., which may indicate the agricultural harvester is on an angled ground surface), the controller 62 may control the first lift actuator 48 to adjust the vertical position of the row units 18 coupled to the first toolbar 38 to reduce the difference between the target row unit height and the monitored row unit height, such that the difference is less than or equal to the threshold value. In addition, the controller 62 may control the first tilt actuator 54 based on actuation of the first lift actuator 48 to maintain the orientation of the row units 18 coupled to the first toolbar 38 relative to the chassis 28 as the first lift actuator 48 varies the vertical position of the row units 18 coupled to the first toolbar 38 relative to the chassis 28. Because the pitch of the agricultural harvester is greater than the threshold pitch, the difference between the target row unit height and the monitored row unit height may be caused by a substantial ground feature (e.g., hill, change in terrain, etc.). Accordingly, adjusting the vertical position of the row units 18 coupled to the first toolbar 38 may enable the row units 18 to substantially maintain the target row unit height.

In certain embodiments, the controller 62 may store a contour map of the ground surface 78. In such embodiments, the controller 62 may control the first lift actuator 48 and the first tilt actuator 54 to cause the row units 18 coupled to the first toolbar 38 to follow the contours of the ground surface 78. In certain embodiments, the controller 62 may control the actuators based on feedback from the row unit height sensor(s) 76 alone, based on the contour map alone, or based on a combination of the contour map and feedback from the row unit height sensor(s) 76.

In certain embodiments, the operator may input a target row unit angle relative to the ground surface 78 into the user interface 68, and the user interface 68 may output the target row unit orientation to the controller 62. The controller 62, in turn, may control the first lift actuator 48 and the first tilt actuator 54 based on the target row unit angle. For example, the controller 62 may control the first tilt actuator 54 to adjust the angle 82 of the row units 18 coupled to the first toolbar 38 relative to the ground surface 78. In addition, based on feedback from the tilt sensor 74, the controller 62 may control the first lift actuator 48 to maintain the vertical position of the row units 18 coupled to the first toolbar 38 relative to the chassis 28 as the first tilt actuator 54 varies the orientation of the row units 18 relative to the chassis 28. As a result, the angle 82 of the row units 18 relative to the ground surface 78 may be adjusted by the actuators during operation of the agricultural harvester, thereby enhancing the efficiency of the harvesting operation (e.g., as compared to a header assembly having a mechanical row unit orientation adjustment assembly that may only be adjusted while the agricultural harvester is not engaged in harvesting operations). As used herein, the “angle” of each row unit 18 relative to the ground surface 78 refers to the angle 82 between a bottom surface of a body 84 of the row unit 18 and the ground surface 78.

In certain embodiments, the controller 62 is configured to control the first lift actuator 48 to transition to a maximum extension, thereby increasing the height of the row units 18 coupled to the first toolbar 38 above the ground surface 78 (e.g., with respect to the vertical axis 52). For example, the operator may provide an input to the user interface 68 indicative of instructions to transition the header assembly 12 into a transport configuration (e.g., to facilitate movement of the agricultural harvester between harvesting locations), and the user interface 68 may output the instructions to the controller 62. The controller 62, in turn, may receive the instructions, and control the first lift actuator 48 to transition to a maximum actuation. The maximum actuation of the first lift actuator 48 may correspond to the maximum extension of the piston rod of the hydraulic cylinder of the first lift actuator, or the maximum actuation of the first lift actuator 48 may correspond to an extension of the piston rod of the hydraulic cylinder of the first lift actuator that rotates the first lift arm 26 to a maximum orientation (e.g., which may be based on the position of various components of the header assembly 12). In addition, the controller 62 may control the first tilt actuator 54 to increase the orientation of the row units 18 coupled to the first toolbar 38 relative to the chassis 28 to a maximum orientation in response to determining the first lift actuator 48 is at the maximum actuation (e.g., based on feedback from the lift sensor 72). As a result, the forward longitudinal ends 71 of the row units 18 coupled to the first toolbar 38 may be positioned higher above the ground surface 78 (e.g., as compared to a header assembly having a four-bar linkage, in which the four-bar linkage moves the row units to a maximum height above the ground surface). As a result, while the header assembly is in the transport configuration, the agricultural harvester may travers rough terrain (e.g., including levees, railroad tracks, rocks, etc.) while substantially reducing or eliminating the possibility of contact between the row units 18 and the terrain. The maximum orientation of the row units 18 coupled to the first toolbar 38 may be based on a maximum extension of the piston rod of the hydraulic cylinder of the first tilt actuator 54 or a maximum orientation of the first toolbar 38 (e.g., which may be based on the position of various components of the header assembly 12).

As previously discussed, in the illustrated embodiment, the hydraulic cylinder of the first lift actuator 48 is arranged such that extension of the piston rod of the hydraulic cylinder drives the first lift arm 26 to pivot upwardly and retraction of the piston rod of the hydraulic cylinder drives the first lift arm 26 to pivot downwardly. However, in other embodiments, the hydraulic cylinder of the first lift actuator may be arranged such that extension of the piston rod of the hydraulic cylinder drives the first lift arm to pivot downwardly and retraction of the piston rod of the hydraulic cylinder drives the first lift arm to pivot upwardly. In addition, in the illustrated embodiment, the hydraulic cylinder of the first tilt actuator 54 is arranged such that extension of the piston rod of the hydraulic cylinder drives the first toolbar 38 to pivot upwardly and retraction of the piston rod of the hydraulic cylinder drives the first toolbar 38 to pivot downwardly. However, in other embodiments, the hydraulic cylinder of the first tilt actuator may be arranged such that extension of the piston rod of the hydraulic cylinder drives the first toolbar to pivot downwardly and retraction of the piston rod of the hydraulic cylinder drives the first toolbar to pivot upwardly.

Furthermore, while the lift actuator 48 includes a single hydraulic cylinder in the illustrated embodiment, in other embodiments, the lift actuator may include multiple hydraulic cylinders, in which each hydraulic cylinder is fluidly coupled to the valve assembly. In such embodiments, the multiple hydraulic cylinders may be arranged in a parallel flow configuration or in a serial flow configuration, and the multiple hydraulic cylinders may be controlled by one or more valves of the valve assembly. In addition, while the tilt actuator 54 includes a single hydraulic cylinder in the illustrated embodiment, in other embodiments, the tilt actuator may include multiple hydraulic cylinders, in which each hydraulic cylinder is fluidly coupled to the valve assembly. In such embodiments, the multiple hydraulic cylinders may be arranged in a parallel flow configuration or in a serial flow configuration, and the multiple hydraulic cylinders may be controlled by one or more valves of the valve assembly. While each actuator includes one or more hydraulic cylinders in the embodiments disclosed above, in certain embodiments, at least one actuator may include other suitable type(s) of actuation device(s) (e.g., alone or in combination with the hydraulic cylinder(s)). For example, in certain embodiments, at least one actuator may include one or more pneumatic cylinders. In such embodiments, the valve assembly may be configured to control the pneumatic cylinder(s), such that the pneumatic cylinder(s) of the actuator(s) are communicatively coupled to the controller via the valve assembly. Furthermore, in certain embodiments, at least one actuator may include one or more electric linear actuators. In such embodiments, the electric linear actuator(s) of the actuator(s) may be communicatively coupled directly to the controller (e.g., the valve assembly may be omitted).

The details, functions, fluid couplings, communicative couplings, control techniques, and variations of the first lift actuator 48 and the first tilt actuator 54, as disclosed above with reference to FIG. 3, may be applied to the second lift actuator and the second tilt actuator, as disclosed above with reference to FIG. 2. For example, in certain embodiments, the second lift actuator includes a single hydraulic cylinder, and the second tilt actuator includes a single hydraulic cylinder. In addition, the valve assembly is fluidly coupled to the hydraulic cylinder of the second lift actuator and to the hydraulic cylinder of the second tilt actuator. The controller is communicatively coupled to the second lift actuator and to the second tilt actuator via the valve assembly, and the controller may control the second lift actuator and the second tilt actuator in the same manner as the first lift actuator and the first tilt actuator, as disclosed above with reference to FIG. 3. For example, the controller may be configured to control the second tilt actuator based on actuation of the second lift actuator to maintain the orientation of the row units coupled to the second toolbar relative to the chassis as the second lift actuator varies the vertical position of the row units coupled to the second toolbar relative to the chassis. In addition, the controller may be configured to control the second lift actuator based on actuation of the second tilt actuator to maintain the vertical position of the row units coupled to the second toolbar relative to the chassis as the second tilt actuator varies the orientation of the row units coupled to the second toolbar relative to the chassis. Furthermore, the controller may be configured to control the second tilt actuator to increase the orientation of the row units coupled to the second toolbar relative to the chassis to the maximum orientation in response to determining the second lift actuator is at the maximum actuation. In addition, in certain embodiments, the header assembly may include a second lift sensor configured to monitor actuation of the second lift actuator and a second tilt sensor configured to monitor actuation of the second tilt actuator. The details, functions, communicative couplings, and variations of the first lift sensor 72 and the first tilt sensor 74, as disclosed above with reference to FIG. 3, may be applied to the second lift sensor and the second tilt sensor.

In certain embodiments, the header assembly includes a row unit height sensor configured to output a sensor signal indicative of a height of a respective row unit coupled to the second toolbar above the ground surface with respect to the vertical axis. In such embodiments, the row unit height sensor is communicatively coupled to the controller, and the controller is configured to receive the sensor signal from the row unit height sensor. Furthermore, the controller may be configured to control the second lift actuator and/or the second tilt actuator based on the height of the row unit above the ground surface. Each of the variations with regard to the number of row unit height sensors, the configuration of the row unit height sensors, determining the monitored row unit height, and control based on the monitored row unit height disclosed above with regard to the row units coupled to the first toolbar apply to the row units coupled to the second toolbar. In certain embodiments, the controller may control the first and second actuators collectively based on feedback from the row unit height sensor(s). In addition, in certain embodiments, the controller may control the first and second actuators independently. For example, the controller may control the first actuators based on feedback from row unit height sensor(s) associated with the row units coupled to the first toolbar, and the controller may control the second actuators based on feedback from the row unit height sensor(s) associated with the row units coupled to the second toolbar. Furthermore, in certain embodiments, the controller may be configured to instruct the user interface to present information determined based on feedback from the row unit height sensor(s) associated with the row units coupled to the second toolbar (e.g., height, average height, minimum height, maximum height).

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical.

1. A header assembly for an agricultural harvester, comprising:
a lift arm pivotally coupled to a chassis of the agricultural harvester;
a toolbar pivotally coupled to the lift arm, wherein the toolbar supports a row unit;
a lift actuator pivotally coupled to the lift arm and pivotally coupled to the chassis of the agricultural harvester, wherein the lift actuator drives the lift arm to rotate relative to the chassis of the agricultural harvester to control a vertical position of the row unit relative to the chassis of the agricultural harvester; and
a tilt actuator pivotally coupled to the lift arm and to the toolbar, wherein the tilt actuator drives the toolbar to rotate relative to the lift arm to control an orientation of the row unit relative to the chassis of the agricultural harvester.

2. The header assembly of claim 1, wherein the lift actuator comprises a hydraulic cylinder, and the tilt actuator comprises a hydraulic cylinder.

3. The header assembly of claim 2, comprising a valve assembly fluidly coupled to the hydraulic cylinder of the lift actuator and to the hydraulic cylinder of the tilt actuator.

4. The header assembly of claim 1, comprising:
a second lift arm pivotally coupled to the chassis of the agricultural harvester;
a second toolbar pivotally coupled to the second lift arm, wherein the second toolbar supports a second row unit;
a second lift actuator pivotally coupled to the second lift arm and pivotally coupled to the chassis of the agricultural harvester, wherein the second lift actuator drives the second lift arm to rotate relative to the chassis of the agricultural harvester to control a vertical position of the second row unit relative to the chassis of the agricultural harvester; and
a second tilt actuator pivotally coupled to the second lift arm and to the second tool bar, wherein the second tilt actuator drives the second toolbar to rotate relative to the second lift arm to control an orientation of the second row unit relative to the chassis of the agricultural harvester.

5. The header assembly of claim 4, wherein the lift actuator comprises a hydraulic cylinder, the tilt actuator comprises a hydraulic cylinder, the second lift actuator comprises a hydraulic cylinder, and the second tilt actuator comprises a hydraulic cylinder.

6. The header assembly of claim 5, comprising a valve assembly fluidly coupled to the hydraulic cylinder of the lift actuator, to the hydraulic cylinder of the tilt actuator, to the hydraulic cylinder of the second lift actuator, and to the hydraulic cylinder of the second tilt actuator.

7. A header assembly for an agricultural harvester, comprising:
a lift arm pivotally coupled to a chassis of the agricultural harvester;
a toolbar pivotally coupled to the lift arm, wherein the toolbar supports a row unit;
a lift actuator pivotally coupled to the lift arm and pivotally coupled to the chassis of the agricultural harvester, wherein the lift actuator drives the lift arm to rotate relative to the chassis of the agricultural harvester to control a vertical position of the row unit relative to the chassis of the agricultural harvester;
a tilt actuator pivotally coupled to the lift arm and to the toolbar, wherein the tilt actuator drives the toolbar to rotate relative to the lift arm to control an orientation of the row unit relative to the chassis of the agricultural harvester; and
a controller communicatively coupled to the lift actuator and to the tilt actuator, wherein the controller comprises a processor and a memory, the controller controls the lift actuator to control the vertical position of the row unit relative to the chassis of the agricultural harvester, and the controller controls the tilt actuator to control the orientation of the row unit relative to the chassis of the agricultural harvester.

8. The header assembly of claim 7, wherein the controller controls the tilt actuator based on actuation of the lift actuator to maintain the orientation of the row unit relative to the chassis of the agricultural harvester as the lift actuator varies the vertical position of the row unit relative to the chassis of the agricultural harvester.

9. The header assembly of claim 8, comprising a lift sensor communicatively coupled to the controller, wherein the lift sensor monitors the actuation of the lift actuator.

10. The header assembly of claim 7, wherein the controller controls the tilt actuator to increase the orientation of the row unit relative to the chassis of the agricultural harvester to a maximum orientation in response to determining the lift actuator is at a maximum actuation.

11. The header assembly of claim 7, wherein the lift actuator comprises a hydraulic cylinder, and the tilt actuator comprises a hydraulic cylinder.

12. The header assembly of claim 7, wherein the controller controls the lift actuator based on actuation of the tilt actuator to maintain the vertical position of the row unit relative to the chassis of the agricultural harvester as the tilt actuator varies the orientation of the row unit relative to the chassis of the agricultural harvester.

13. The header assembly of claim 7, wherein the controller controls the lift actuator, the tilt actuator, or a combination thereof, based on a contour map of the ground surface.

14. The header assembly of claim 7, comprising a row unit height sensor communicatively coupled to the controller, wherein the row unit height sensor outputs a sensor signal indicative of a height of the row unit above a ground surface, and the controller receives the sensor signal and to control the lift actuator, the tilt actuator, or a combination thereof, based on the height of the row unit above the ground surface.

15. An agricultural harvester, comprising:
a chassis; and
a header assembly, comprising:
a row unit;
a lift arm pivotally coupled to the chassis;
a toolbar pivotally coupled to the lift arm, wherein the toolbar supports the row unit;
a lift actuator pivotally coupled to the lift arm and to the chassis, wherein the lift actuator drives the lift arm to rotate relative to the chassis to control a vertical position of the row unit relative to the chassis; and
a tilt actuator pivotally coupled to the lift arm and to the toolbar, wherein the tilt actuator drives the toolbar to rotate relative to the lift arm to control an orientation of the row unit relative to the chassis.

16. The agricultural harvester of claim 15, wherein the header assembly comprises a controller communicatively coupled to the lift actuator and to the tilt actuator, the controller comprises a processor and a memory, the controller controls the lift actuator to control the vertical position of the row unit relative to the chassis, and the controller controls the tilt actuator to control the orientation of the row unit relative to the chassis.

17. The agricultural harvester of claim 16, wherein the controller controls the tilt actuator based on actuation of the lift actuator to maintain the orientation of the row unit relative to the chassis as the lift actuator varies the vertical position of the row unit relative to the chassis.

18. The agricultural harvester of claim 16, wherein the controller controls the tilt actuator to increase the orientation of the row unit relative to the chassis to a maximum orientation in response to determining the lift actuator is at a maximum actuation.

19. The agricultural harvester of claim 15, wherein the lift actuator comprises a hydraulic cylinder, and the tilt actuator comprises a hydraulic cylinder; and
wherein the header assembly comprises a valve assembly fluidly coupled to the hydraulic cylinder of the lift actuator and to the hydraulic cylinder of the tilt actuator.

20. The agricultural harvester of claim 15, wherein the header assembly comprises:
a second lift arm pivotally coupled to the chassis;
a second toolbar pivotally coupled to the second lift arm, wherein the second toolbar supports a second row unit;
a second lift actuator pivotally coupled to the second lift arm and to the chassis, wherein the second lift actuator drives the second lift arm to rotate relative to the chassis to control a vertical position of the second row unit relative to the chassis; and
a second tilt actuator pivotally coupled to the second lift arm and to the second tool bar, wherein the second tilt actuator drives the second toolbar to rotate relative to the second lift arm to control an orientation of the second row unit relative to the chassis.
